(19) United States
(12) Patent Application Publication
(10) Pub. No.: US 2026/0100478 A1
(43) Pub. Date: Apr. 9, 2026

(54) SOLID-STATE ELECTROLYTE SLURRY MIXING AND COATING

(71) Applicant: A123 Systems LLC, Novi, MI (US)

(72) Inventors: Ethan Boeding, Watertown, MA (US); John Flynn, Watertown, MA (US); David Laughman, Acton, MA (US)

(21) Appl. No.: 19/347,625

(22) Filed: Oct. 1, 2025

Related U.S. Application Data
(60) Provisional application No. 63/703,122, filed on Oct. 3, 2024.

(51) Int. Cl. H01M 50/403; H01M 10/0562; H01M 10/0585; H01M 50/414; H01M 50/426; H01M 50/431; H01M 50/443; H01M 50/46

(52) U.S. Cl. CPC H01M 50/403; H01M 10/0562; H01M 10/0585; H01M 50/414; H01M 50/426; H01M 50/431; H01M 50/443; H01M 50/46; H01M 2300/0068

(57) ABSTRACT

Methods are disclosed herein for preparing a smooth solid electrolyte slurry and coating the slurry onto a substrate to form a separator of a solid-state battery. In one example, the method includes combining solid electrolyte, solvent, and a binder solution to form a slurry, followed by mixing the slurry to form a smooth slurry. Mixing the slurry includes a combination of mixing under non-vacuum conditions, mixing under vacuum conditions, and milling under vacuum and/or non-vacuum conditions.

### CROSS REFERENCE TO RELATED APPLICATION

The present application claims priority to U.S. Provisional Application No. 63/703,122, entitled “SOLID-STATE ELECTROLYTE SLURRY MIXING AND COATING” and filed Oct. 3, 2024. The entire content of the above application is hereby incorporated by reference for all purposes.

### TECHNICAL FIELD

The present description relates generally to methods for solid-state electrolyte slurry mixing and coating.

### BACKGROUND AND SUMMARY

Preparation of solid-state battery separators may include mixing a slurry and coating a substrate with the slurry. For example, the slurry may comprise a mixture of a solvent, a binder, and a solid-state electrolyte such as a sulfide solid electrolyte. However, conventional solvent-binder packages, such as those used in lithium-ion battery cells and based on polar solvent systems, may not be compatible with sulfide solid-state electrolyte. Specifically, mixing a solvent-binder package with a sulfide solid-state electrolyte may initiate formation of agglomerates over a threshold particle size, thereby reducing effectiveness of coating the substrate with the mixture due to increased viscosity and surface defects. For example, when coating with a slot-die, agglomerates may leave streaks in the coating and pile up at a slot-die interface. Further, agglomerates may catalyze dendrite formation in solid-state batteries, thus causing non-uniform binder distribution, and mechanical and electrical discontinuities within a surrounding matrix. The presence of agglomerates may be evinced by particle size analysis and visual inspection.

Thus, mixing and coating methods are disclosed herein to address at least some of the issues described above which have been recognized by the inventors. For example, the methods disclosed herein may produce a slurry with reduced agglomerate formation. For example, reduced agglomerate formation may include zero or negligible occurrence of agglomerate formation. A mixing method for producing a slurry may comprise mixing a solvent, a powder, and a binder solution under non-vacuum conditions to form a slurry; mixing the slurry under vacuum conditions; repeatedly basket milling under non-vacuum conditions and mixing under vacuum conditions in an alternating pattern until a maximum particle size of the slurry is below a threshold particle size; and mixing the slurry under vacuum conditions. Mixing may include dissolver mixing, planetary mixing, or any other mixing method for combining solid and liquid materials. The aforementioned mixing means may be used in addition to basket milling as a pre-and/or post-processing mixing step.

In this way, implementing the mixing method may facilitate thorough and stable dispersion of the sulfide solid-state electrolyte materials without compromising their intrinsic structural and electrical functionalities. Further, by using the methods of mixing and coating disclosed herein, the sulfide slurry may be scaled to larger volumes, such as 100-2000 mL, for coating significantly larger areas without agglomerates over the threshold particle size, thereby increasing a quality of the coating. For example, a roll to roll process may be used for coating the larger areas. Further, a quality of a battery or other system wherein the coating is incorporated may be increased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a flowchart of an exemplary method for mixing a smooth slurry according to the present disclosure.

FIG. 2 shows a flowchart of an exemplary method for coating a substrate with the smooth slurry according to the present disclosure.

FIG. 3 shows a schematic of steps of an example mixing and coating process of the present disclosure.

FIG. 4 shows a graph of example particle size distribution (PSD) data of the smooth slurry produced by the mixing method disclosed herein.

FIG. 5 shows a graph of viscosity over a range of shear rates for the smooth slurry after different steps of the mixing method of the present disclosure.

FIGS. 6A-6C show casted separators after different steps of the mixing method of the present disclosure.

FIG. 7 shows a flowchart of a process according to the present disclosure of producing a casted separator.

FIG. 8 shows a graph of example PSD data of a slurry produced by a first prior art method.

FIG. 9 shows a casted separator produced by the first prior art method.

FIG. 10 shows a graph of example PSD data for a slurry produced by a second prior art method.

FIGS. 11A-11C show casted separators including slurries produced by the second prior art methods.

### DETAILED DESCRIPTION

The following description relates to methods for mixing solid-state electrolyte slurries and coating the slurries onto substrates. For example, the slurry may be a sulfide electrolyte slurry coated onto an aluminum sheet, a cathode, an anode, or other substrate. The coating may be incorporated into a solid-state battery as a separator.

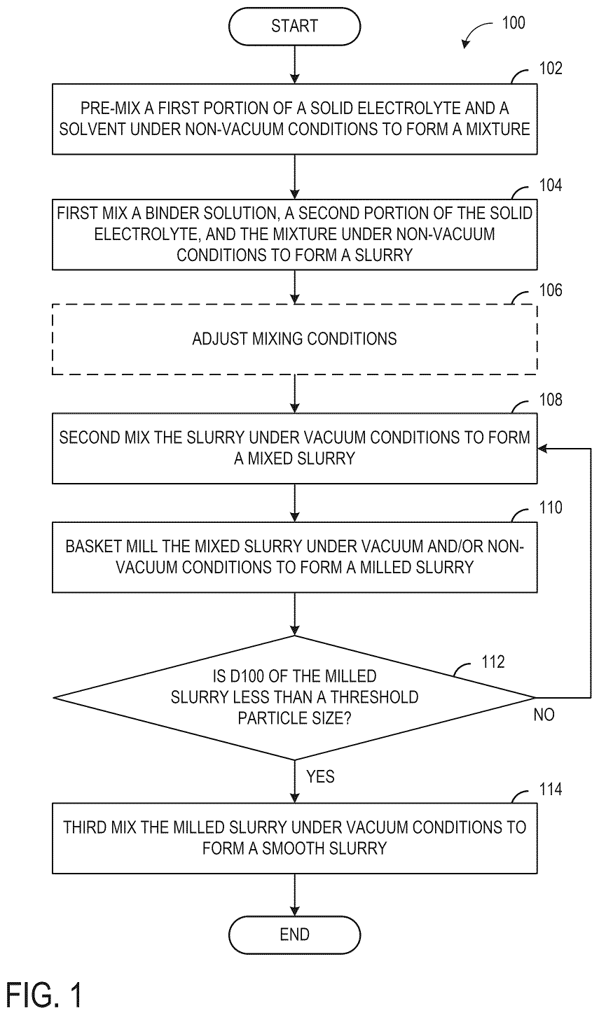

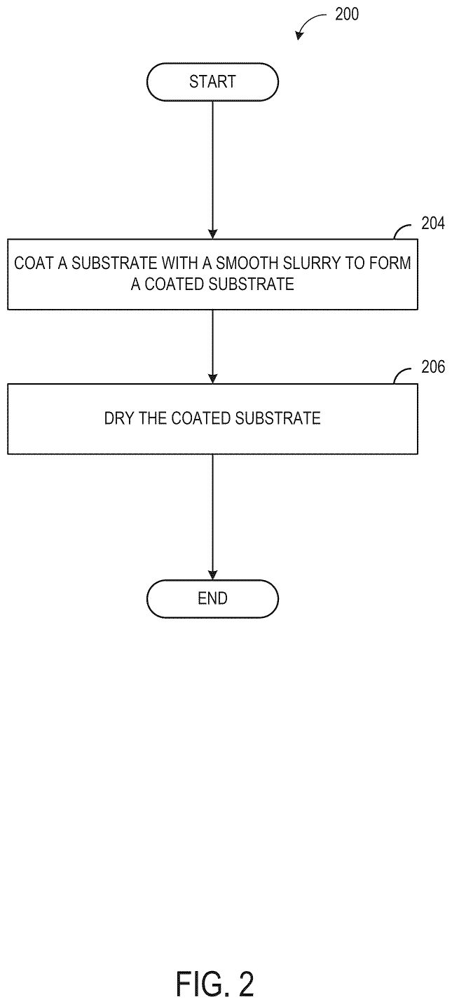

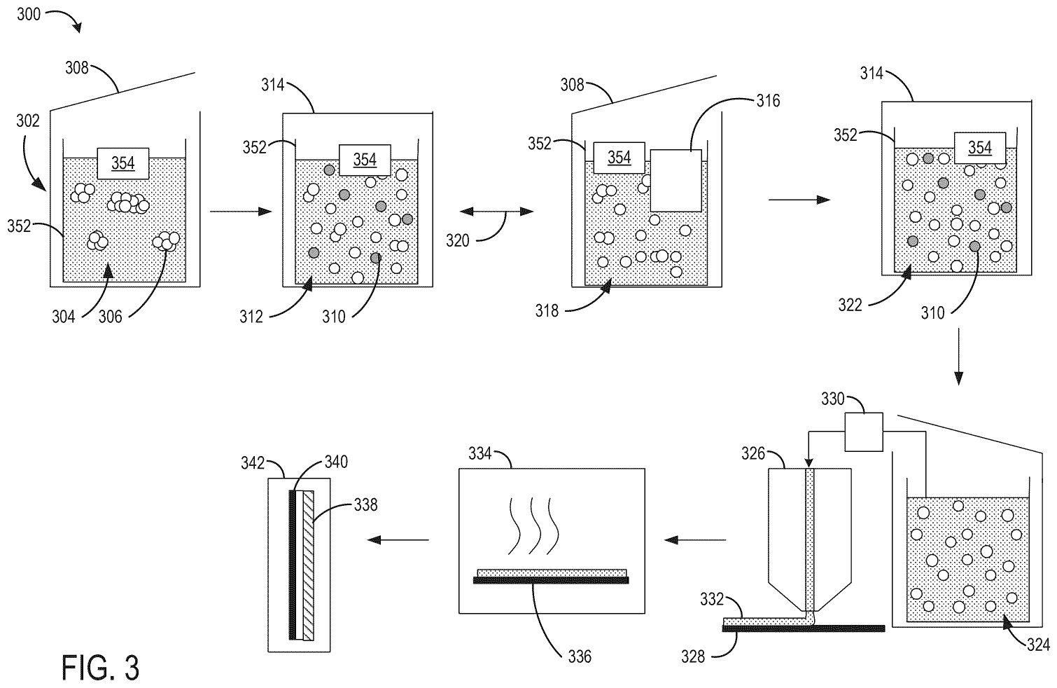

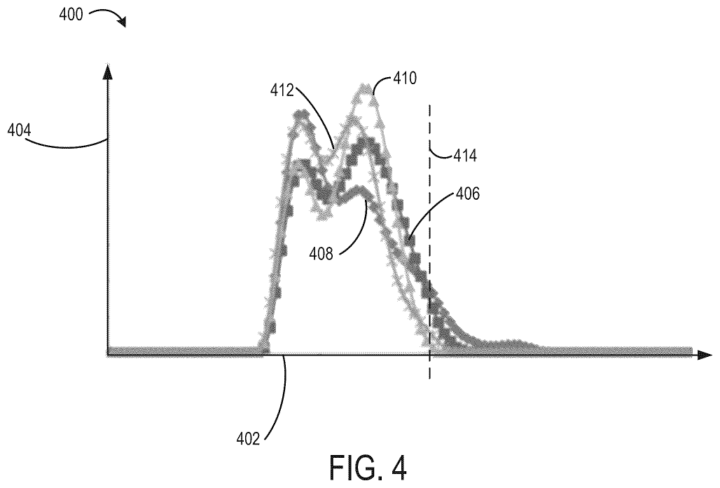

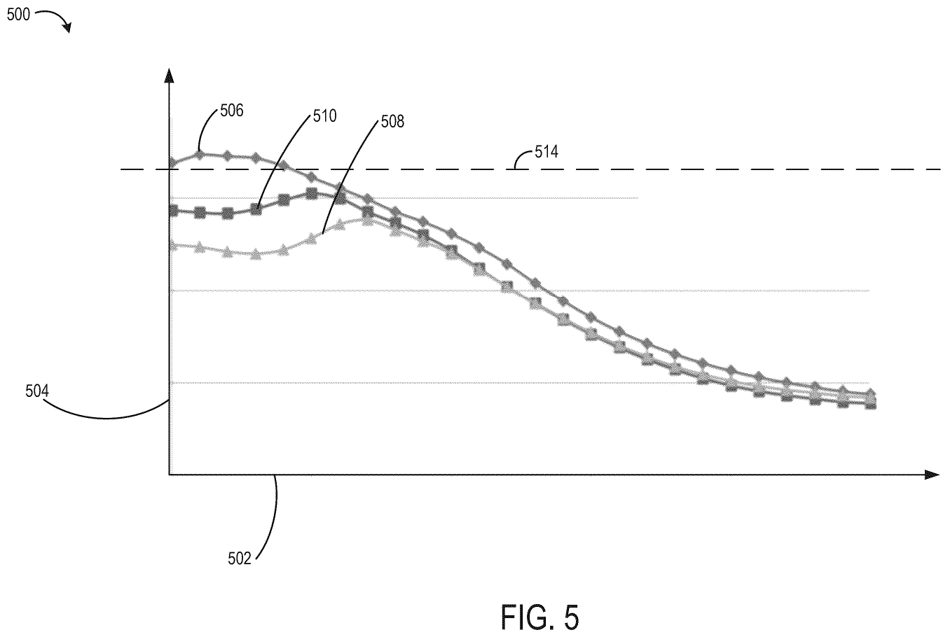

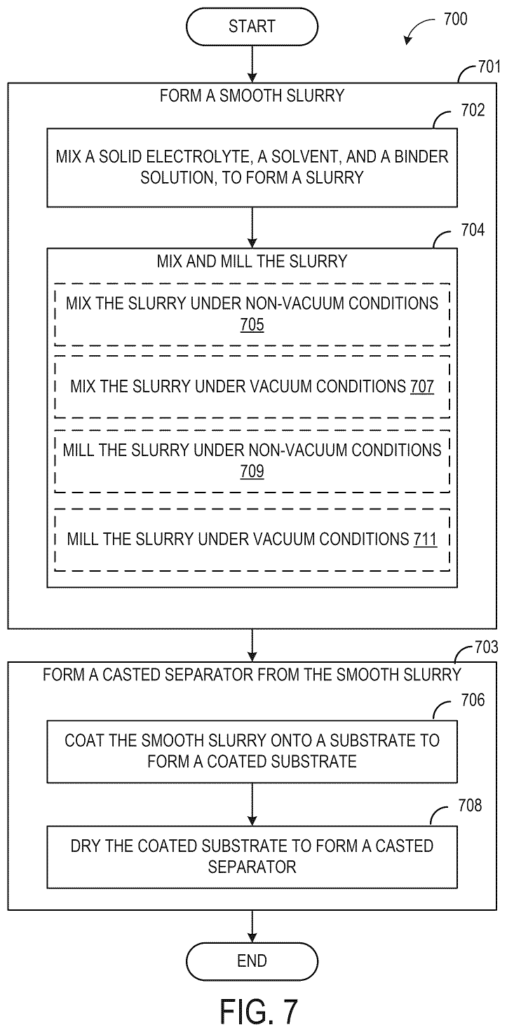

FIG. 1 shows a flowchart of an exemplary mixing method of the present disclosure for preparing a slurry. The mixing method described in reference to FIG. 1 may comprise a series of mixing under non-vacuum conditions, mixing under vacuum conditions, and basket milling under vacuum and/or non-vacuum conditions in order to achieve a maximum particle size below a threshold particle size and a desired viscosity wherein the slurry flows with gravity. As used herein, mixing may include dissolver mixing, planetary mixing, other mixing methods for combining solids and liquids, or a combination thereof. A graph of viscosity of the slurry over a range of shear rates at different steps of the mixing method is shown in FIG. 5. The slurry produced by the method in FIG. 1 may have advantageous properties, compared to the prior art methods. For example, the slurry produced by the mixing methods of the present disclosure may have fewer agglomerates and reduced maximum particle size, compared to prior art methods. Example PSD data for a slurry produced with the method of FIG. 1 is shown in FIG. 4. Further, slurries prepared by the method of FIG. 1 may have a reduced viscosity due to reduced air bubbles and smaller particle sizes. Thus, slurries made by the methods of the present disclosure may be more conducive to application as a coating, such as by an example coating method of the present disclosure shown as a flowchart in FIG. 2. FIG. 7 shows a flowchart of a method of creating a separator of a solid-state battery according to the present disclosure, wherein the method of FIG. 7 includes at least some of the steps of the methods of FIGS. 1 and 2. FIG. 3 schematically depicts a process of producing a casted separator of a solid-state battery, such as by implementing the method of FIG. 7.

Preparing a slurry by prior art methods may produce a slurry with a maximum particle size (D100) over a threshold particle size above which agglomerates may impede a subsequent coating process, cause uneven distribution of electrolyte in the coating, and result in dendrite formation in the solid-state battery. For example, the threshold particle size may be one third or less of a thickness of the coating. Agglomerates (e.g., particles above the threshold particle size) may result in non-uniform mechanical properties that can initiate cracks or other degradation. Further, agglomerates above the threshold particle size may lead to non-uniform current densities which may reduce performance envelope and life-time of the battery. Additionally, prior art methods may not be scalable to larger volumes of slurry production to meet quantity demands.

For example, bench-scale (e.g., 10 mL) mixing of solvent binder packages and sulfide electrolyte powder with a centrifugal mechanism may result in a slurry without agglomerates over the threshold particle size, but upon scaling to larger volume (e.g., 100-2000 mL) of centrifugal mixing, a ratio of energy demand to yield may increase, thereby reducing efficiency. Other prior art methods more suitable to larger volumes, including dissolver mixing, may result in larger agglomerates forming in the slurry or damage to the binder's properties. Sonication may not be able to break up agglomerates following mixing (e.g., dissolver mixing, planetary mixing, or the like) due to high solids content (e.g., approximately 60 wt % or more) in the slurry. Roller milling may be able to break up agglomerates, indicating agglomerates can be split up by mechanical processes. However, reducing agglomerate size with a roller mill may result in a low yield (e.g., 20-30 wt %).

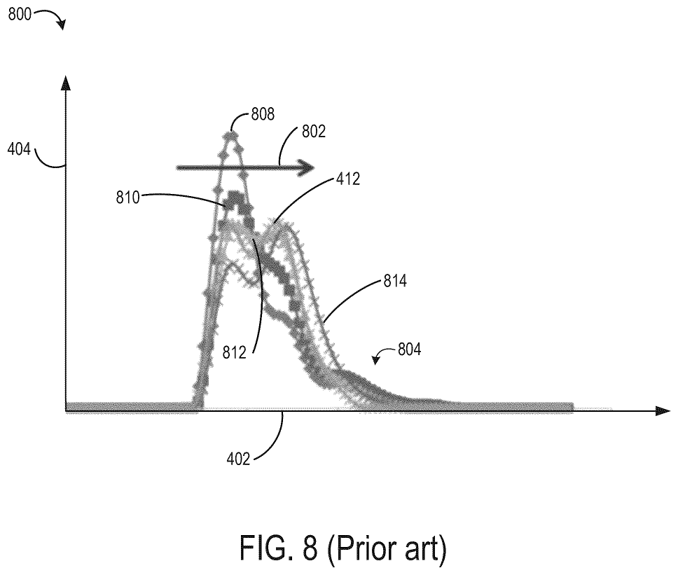

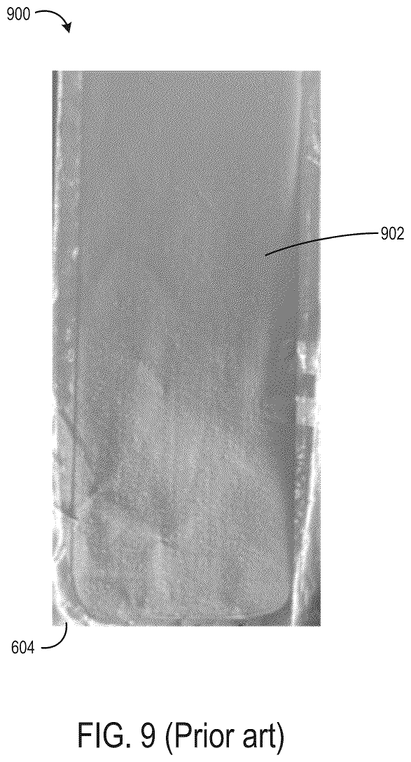

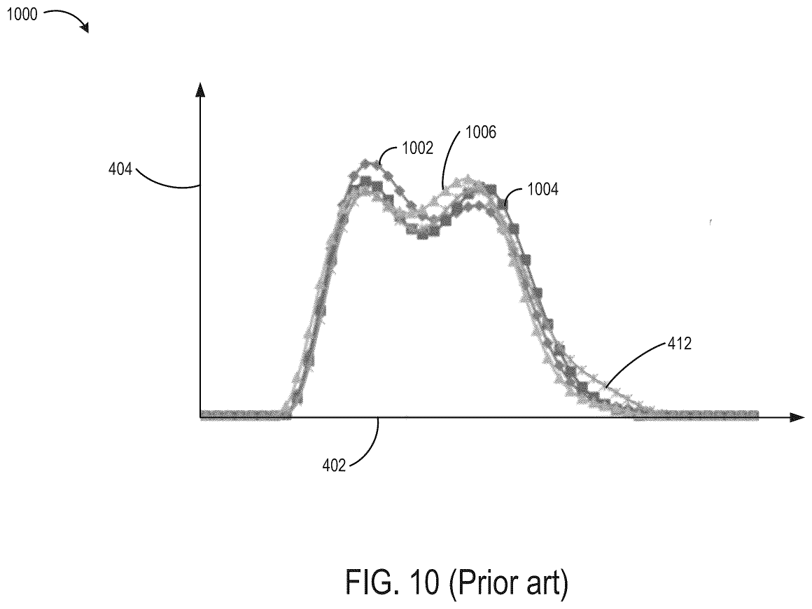

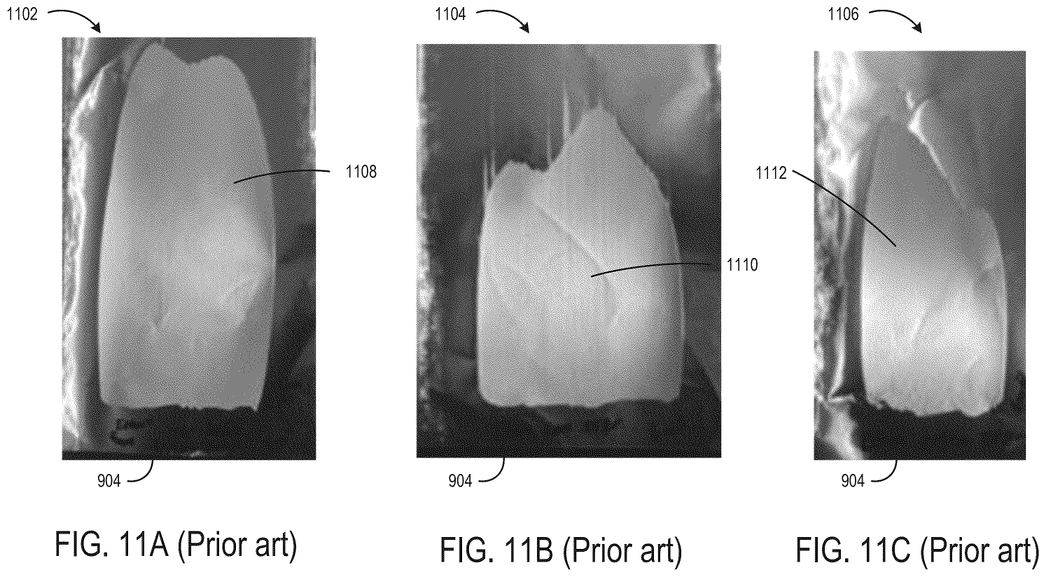

A slurry produced by dissolver mixing alone may have a particle size distribution (PSD) shown in a PSD graph in FIG. 8, and produce a coating with undesirable texture (e.g., streaks, bumps, etc.) as shown in FIG. 9, indicating agglomerate formation and presence of particles larger than the threshold particle size. Another example prior art method of dissolver mixing followed by roller milling may produce slurries with a PSD shown in a graph in FIG. 10. Examples of casted separators including coatings comprising slurries produced by dissolver mixing followed by roller milling are shown in FIGS. 11A-11C.

It is to be understood that the specific assemblies and systems illustrated in the figures, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIG. 1, a flowchart of a method 100 is shown for mixing a slurry, wherein the slurry comprises a solid electrolyte, a solvent, and a binder. The method 100 may produce a smooth slurry with reduced particle size compared to other slurry preparation methods. In this way, the smooth slurry may be more thoroughly mixed, without agglomerates of solid electrolyte over a threshold particle size. The threshold particle size may be selected according to a composition of the slurry. The composition of the slurry may refer to the materials mixed into the slurry, in one example. Additionally or alternatively, the threshold particle size may be selected according to a separator thickness. The separator thickness may be a thickness of a separator resulting from coating the slurry onto a substrate. The threshold particle size may be less than the separator thickness. For example, the threshold particle size may be approximately one third or less of the separator thickness. As another example, the threshold particle size may be a maximum particle size of the solid electrolyte. The maximum particle size of the solid electrolyte may be in a range of 1-50 μm. The threshold particle size may balance properties of the separator. For example, as the agglomerates are dispersed, packing density increases, and tortuosity and resistivity both decrease. With larger particles, the minimum separator thickness increases but the number of interfaces the ion has to cross decreases. As an example, the separator thickness may be 5-300 μm. Accordingly, the threshold particle size may be 1-100 μm, approximately one third or less of the thickness, or a maximum particle size of the solid electrolyte.

Thus, a smooth slurry produced from the method 100 may be more suitable for an intended use than a slurry comprising agglomerates. The intended use may be coating the slurry to form a solid-state battery separator, for example. The resulting smooth slurry may be a sulfide solid electrolyte slurry for use as a solid-state battery separator, in one example. However, the method 100 may be used to mix slurries with different intended purposes without departing from the scope of the present disclosure.

At 102, the method 100 includes pre-mixing (e.g., via dissolver mixing, planetary mixing, and/or the like) a first portion of solid electrolyte and solvent under non-vacuum conditions to form a mixture. For example, pre-mixing may include dissolver mixing. As an additional or alternative example, pre-mixing may include planetary mixing. For example, the solvent may be a non-polar solvent such as hexyl butyrate, butyl butyrate, xylene, heptane, anisole, toluene, other liquid non-polar solvents, or a mixture thereof. The solid electrolyte may be sulfide powder. However, other solvents or solid electrolytes may be used in other examples. As used herein, a solid electrolyte may include any form of solid that is ionically conductive. In one example, the solid electrolyte is provided in a powder form. In alternative examples, the solid electrolyte may be provided in other solid forms, such as granules, flakes, or aggregate particles. A sulfide powder may include at least a non-zero threshold amount of anions of sulfur. A first amount of solid electrolyte and a second amount of solvent may be added. The first amount may be greater than the second amount in some examples. The first amount and the second amount may be within a range of 50 g to 500 g, in at least some examples. Additionally or alternatively, the first amount and the second amount may be added in a first ratio by weight of approximately 1.1 to 1, respectively, or up to approximately 2 to 1. The first portion of solid electrolyte may be a part of a total amount of solid electrolyte mixed into the slurry during the method 100. The part may be a non-zero amount that is less than the total amount. For example, the part may be approximately half of the total amount.

Pre-mixing may comprise dissolver mixing, planetary mixing, and/or other mixing methods for combining solids and liquids. Any suitable mixing methods may be used. Milling methods, such as basket milling, may be separate from the mixing methods, or used in combination. For example, mixing methods, including dissolver mixing, planetary mixing, etc., may be used pre-milling or post-milling. The mixing container may be any container suitable for mixing the solvent and the solid electrolyte. For example, the mixing container may be of a mixing system, such as a dissolver, or other appropriate mixing system for combining both solid and liquid materials. In at least some examples, a butterfly attachment may be used to mix the solid electrolyte and the solvent. For example, pre-mixing may occur with the butterfly attachment rotating at a first rotational speed within the mixing container, in some examples. Mixing in subsequent steps of the method 100 may occur with different rotational speeds faster or slower than the first rotational speed in such examples. A sweeper or planetary mixing method may be used in parallel with or alternatively to dissolver mixing. Pre-mixing may continue with the first rotational speed until the solid electrolyte is dispersed into the solvent, for example until no chunks of solid electrolyte are observed. For example, pre-mixing may continue until the solid electrolyte is not observed visually, by particle size testing, or further analysis. Pre-mixing of the first portion of solid electrolyte and the solvent at 102 results in the mixture.

At 104, the method 100 includes first mixing a binder solution, a second portion of the solid electrolyte, and the mixture under non-vacuum conditions to form a slurry. The second portion of the solid electrolyte may be the remainder of the total amount of the solid electrolyte, such as an amount equal to the first portion subtracted from the total amount. First mixing may occur with the blade rotating at a second rotational speed less than the first rotational speed, in at least some examples. In such an example, the rotational speed of the blade may be reduced just prior to adding the binder solution and the solid electrolyte to the mixing container. For example, the second rotational speed may be within a range inclusively between 500 rpm and 1000 rpm and the first rotational speed may be inclusively between 1000 rpm and 2000 rpm. The first rotational speed range and the second rotational speed range may overlap. Thus, first mixing at 104 may occur at approximately the same rotational speed as pre-mixing at 102, in some examples.

In at least some examples, the binder solution may be a solution including a dilution solvent and a rubber binder. The dilution solvent may be or include a non-polar solvent. For example, the dilution solvent may be or include hexyl butyrate, butyl butyrate, xylene, anisole, heptane, toluene, another non-polar solvent, or a combination thereof. The rubber binder may comprise one or more of nitrile butadiene rubber (NBR), hydrogenated nitrile butadiene rubber (HNBR), styrene-butadiene copolymer (SRB), styrene-butadiene-styrene (SBS), polyvinylidene fluoride (PVPF), and hexafluoroporpylene (HFP). A more specific example of NBR may be NBR2860. The binder solution may be 1-10 wt % rubber binder. Correspondingly, the binder solution may include 90-99 wt % dilution solvent. In another example, the binder solution may be 5-15% rubber. However, other concentrations are possible without departing from the scope of the present disclosure. Further, as an alternative to the binder solution, equivalent amounts of the respective dilution solvent and the rubber binder may be mixed directly with the mixture rather than being formed into a binder solution there before. As described above, the solid electrolyte may be an ionically conductive powder such as a sulfide powder, or other ionically conductive solid. A third amount of binder solution and a fourth amount of solid electrolyte may be added to the mixing container. The third amount and the fourth amount may be approximately equal. Further, the third amount and the fourth amount may be approximately equal to the first amount (e.g., amount added at 102). Additionally or alternatively, the first amount, the second amount, the third amount, and the fourth amount may be relatively proportioned such that the slurry is approximately 50-80 wt % solids. Completing 104 may result in a slurry forming. The slurry may include agglomerates over the threshold size at this point in the method 100.

At 106, the method 100 optionally includes adjusting mixing conditions. Mixing conditions may include blade type, blade speed, temperature, etc.). Due to adding materials to the mixture at 104, the slurry may be thicker, compared to the mixture. Thus, for example, the rotational speed of the blade may be increased to a third rotational speed. The third rotational speed may be inclusively between 2000 rpm and 3000 rpm, for example. Thus, in some examples, the first rotational speed may be approximately equal to the third rotational speed. In other examples, the third rotational speed may be greater than the first rotational speed. Mixing under the adjusted conditions may continue until the slurry is fully combined (e.g., until there are no chunks of solid electrolyte visibly present).

Mixing conditions may be further adjusted after the slurry is fully combined. For example, a second blade may be installed, wherein the second blade is smaller than the first blade. For example, the second blade may be a dissolver blade. The slurry may be mixed using the second blade rotating at a fourth rotational speed, faster than the third rotational speed. For example, the fourth rotational speed may be approximately 6800 rpm. Additionally or alternatively, the fourth rotational speed may be at least twice the third rotational speed. Due to the higher rotational speed, a higher temperature than a threshold temperature (e.g., 70° C.) of the mixing container and the slurry may be observed. The slurry may be cooled to below the threshold temperature by one or more cooling methods, for example with an isopropyl alcohol (IPA) bath, double walled chilling container, and/or the like.

Thus adjusting mixing conditions at 106 may optionally include one or more of adjusting blade rotational speed, changing blade size, and decreasing temperature with one or more cooling methods. The adjustments described above are exemplary and non-limiting as to the scope of the method 100. Further, adjusting mixing conditions may occur in other points during the method 100 additionally or alternatively, such as before 104 and/or after 108, without departing from the scope of the present disclosure.

At 108, the method 100 includes second mixing the slurry under vacuum conditions to form a mixed slurry. Second mixing may include planetary mixing, dissolver mixing, or the like. For example, the mixing container may be moved into a vacuum chamber, wherein the pressure is slowly reduced from atmospheric pressure (e.g., 760 mmHg) to a vacuum pressure. The vacuum pressure is less than the atmospheric pressure. For example, the vacuum pressure may be nearly 0 mmHg. Additionally or alternatively, the vacuum pressure may be 5% or less of the atmospheric pressure. Bubbles popping on the surface of the slurry may be observed due to the vacuum conditions. The slurry may be left in the vacuum chamber maintained at the vacuum pressure until popping bubbles are no longer observed. The popping bubbles may be observed visually, auditorially, or via further analysis of the slurry. Second mixing may occur under vacuum conditions while the slurry is in the vacuum chamber. For example, the first blade may be attached to the mixing system and used to mix the slurry. For example, second mixing in the vacuum chamber may occur with the blade spinning at a fifth rotational speed to remove air from the slurry, wherein the fifth rotational speed is less than the fourth rotational speed and greater than the third rotational speed. For example, the fifth rotational speed may be 5000 rpm. By removing air from the slurry, a viscosity of the mixed slurry may be reduced, thereby advantageously adjusting rheology of the slurry for coating purposes. The reduction in viscosity is demonstrated in the viscosity graph 500 of FIG. 5.

At 110, the method 100 includes basket milling the mixed slurry under vacuum and/or non-vacuum conditions to form a milled slurry. In examples where basket milling occurs under both vacuum and non-vacuum conditions, the vacuum and non-vacuum conditions may occur sequentially, such as basket milling under non-vacuum conditions followed by basket milling under vacuum conditions, or vice versa. An alternating pattern of vacuum and non-vacuum conditions during basket milling is also possible. Basket milling, compared to other milling methods, may provide higher product yield, more effectively disperse agglomerates, and may not reduce or compromise the mechanical properties of the binder and corresponding coating. In some examples, dissolver mixing, planetary mixing, or any other mixing method for combining solid and liquid materials may be used in addition to basket milling as a pre-and/or post-processing mixing step.

As an example, the basket mill may be installed on the mixing system (e.g., the dissolver). The mixed slurry may be milled with the blade rotating at a sixth rotational speed. The sixth rotational speed may be less than the fifth rotational speed. Additionally or alternatively, the sixth rotational speed may be greater than the third rotational speed. For example, the sixth rotational speed may be approximately 3400 rpm. A duration of milling with the basket mill may be a predetermined number of minutes. The predetermined number of minutes may be between 10 and 20 minutes, as an example. Additionally or alternatively, milling with the basket mill may continue until the milled slurry no longer flows into the basket mill with gravity due to an increased viscosity. A sweeper or planetary mixer may be used in parallel with the basket mill.

At 112, the method 100 includes determining whether the largest particle size (D100) of the milled slurry is less than a threshold particle size. Determining the D100 may entail analyzing the milled slurry with a particle analyzer capable of generating a PSD from a slurry sample. For example, particle size analysis may produce a PSD, and the D100 may be determined therefrom for comparison with the threshold particle size. The threshold particle size may be selected depending on an application for the slurry and corresponding desired qualities thereof (e.g., smooth surface of the coating, regular distribution of solid electrolyte, etc.). For example, the application of the slurry, or the intended use of the slurry, may be coating a substrate to form a sold-state battery separator. For example, as described above, the threshold particle size may be approximately one third or less of a thickness of a coating comprising the slurry. Additionally or alternatively, the threshold particle size may be the maximum particle size of the solid electrolyte. Additionally or alternatively, the threshold particle size may be in a range of 1-50 μm. Additionally or alternatively, the threshold particle size may be in a range of 10-20 μm. Additionally or alternatively, the threshold particle size may be in a range of 30-40 μm. Additionally or alternatively, the threshold particle size may be in a range of 5-25 μm.

If the D100 is not less than the threshold particle size (NO at 112), the method 100 returns to 108. Steps 108 and 110 may be repeated until the D100 is less than the threshold particle size. Repetition of steps 108 and 110 may occur in an alternating pattern. In other words, the slurry may be repeatedly second mixed by a dissolver, planetary mixing system, and/or the like under vacuum conditions and basket milled in an alternating pattern until the D100 of the milled slurry is less than the threshold particle size. Each time steps 108 and 110 are repeated, parameters of the second mixing and milling conditions may change. For example, milling with the basket mill for a first time may take a first duration and milling with the basket mill a second time may take a second duration longer or shorter than the first duration. For example, the first basket mill mixing duration may be 10 minutes and the second basket mill mixing duration may be 20 minutes. Further, blade rotational speeds may differ. Alternatively, parameters may be kept consistent for each repetition of 108 and 110, in some examples. The steps 108 and 110 may be repeated twice in some examples. However, in other examples, 108 and 110 may be repeated three or more times. Thus, 108 and 110 may be performed one or more times each in the method 100.

If the D100 is less than the threshold particle size (YES at 112), the method 100 proceeds to 114. At 114, the method 100 includes third mixing the milled slurry under vacuum conditions to produce a smooth slurry. For example, 114 may be another repetition of 108. As such, the mixing container may be moved into a vacuum chamber, wherein the pressure is slowly reduced from atmospheric pressure to the vacuum pressure. Bubbles popping on the surface of the milled slurry may be observed due to the vacuum drawing out trapped air in the milled slurry. The milled slurry may be left in the vacuum chamber maintained at the vacuum pressure until popping bubbles are no longer observed. Third mixing may occur while the milled slurry is in the vacuum chamber. For example, the first blade may be attached to the mixing system and used to mix the slurry. For example, mixing in the vacuum chamber may occur with the blade spinning at the fifth rotational speed to remove air from the slurry. By exposing the milled slurry to vacuum conditions, a viscosity of the milled slurry may be reduced. Due to the final vacuum mixing at 114, the smooth slurry may flow with a desired viscosity. For example, the viscosity may be lowered enough for the smooth slurry to be pumped into a coating device and applied onto a surface as a coating. Further description of the effects of vacuum mixing on viscosity are described below in regards to FIG. 5.

The method 100 ends. By completing the method 100, a slurry having a maximum particle size below the threshold particle size and the desired viscosity may be obtained. For example, the smooth slurry resulting from the method 100 may be applied as a coating to a substrate by method 200 of FIG. 2. Further, the smooth slurry may be incorporated in a system, for example as a separator in a solid-state battery system.

Including two or more steps in a mixing method, such as the method 100 of FIG. 1, where mixing is performed under vacuum conditions may reduce a viscosity of the smooth slurry below a threshold viscosity. The threshold viscosity may be a maximum viscosity at which the smooth slurry flows with gravity. Alternatively, the threshold viscosity may be a minimum viscosity at which the smooth slurry does not flow with gravity. Other threshold viscosities are possible without departing from the scope of the present disclosure. In this way, the smooth slurry may have preferable rheology for subsequently coating substrate with the smooth slurry. For example, the smooth slurry may flow through a pump with a desired flow rate due to the viscosity being below the threshold viscosity.

Turning to FIG. 5, a viscosity graph 500 is shown of viscosity over a range of shear rates for a slurry after different steps of a mixing method of the present disclosure. For example, the method may include basket milling for a first duration, mixing under vacuum conditions, and basket milling for a second duration, in the order listed. The first duration in this example is 10 minutes the second duration in this example is 20 minutes, though other combinations of durations are possible as described above. The method may be one embodiment of the method 100, with additional steps not represented in the viscosity graph 500. For example, mixing under vacuum conditions may occur according to 108 of FIG. 1, and basket milling for the first duration and the second duration may occur as described with reference to 110 of FIG. 1.

The viscosity graph 500 includes a horizontal axis 502 with shear rate increasing logarithmically in the direction indicated by the arrow thereof, and a vertical axis 504 with shear viscosity increasing logarithmically in the direction indicated by the arrow thereof. A trace 506 (with diamonds) shows viscosity of the slurry after basket milling for the first duration and before mixing under vacuum conditions, such as the milled slurry of FIG. 1. A trace 508 (with triangles) may show viscosity of the slurry after mixing under vacuum conditions and before basket milling for the second duration, such as the mixed slurry of FIG. 1. A trace 510 (with squares) may show viscosity of the slurry after basket milling for the second duration, the milled slurry of FIG. 1. The trace 510 may remain below a threshold viscosity 514.

As shown in the viscosity graph 500, mixing under vacuum conditions may lower viscosity of the slurry for at least some shear rates. Without being bound by theory, the mixing under vacuum conditions may lower the viscosity of the slurry for the at least some shear rates due to releasing air pockets trapped during prior milling. Conversely, basket milling may increase viscosity of the slurry, over at least some shear rates. Thus, a final step of a mixing method of the present disclosure may include vacuum mixing to achieve a lowered viscosity prior to coating a surface with the slurry.

The viscosity graph 500 shows example viscosity data for slurries at different steps of a mixing method of the present disclosure but does not limit the method to the steps included in FIG. 5. For example, although not shown in the viscosity graph 500, the slurry may undergo additional mixing, milling, and/or vacuum exposure steps before, after, and/or between the steps represented in the viscosity graph 500, as described above with reference to the method 100 shown as a flowchart in FIG. 1.

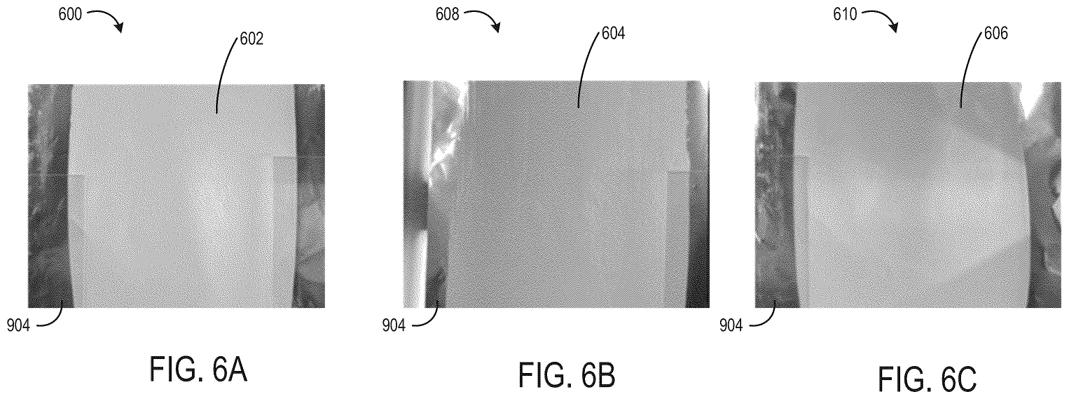

Turning to FIG. 2, an exemplary method 200 of the present disclosure is shown for coating a substrate with a smooth slurry, such as a smooth slurry produced by the method 100 of FIG. 1. For example, the substrate may be an aluminum foil, an anode, or a cathode. The smooth slurry may be referred to as a coating after being applied to the substrate. The result of coating with the method 200 may be a casted separator of a solid-state battery, examples of which are shown in FIGS. 6A-6C.

The method 200 begins at 204, wherein a substrate is coated with a smooth slurry. For example, the smooth slurry may be formed by mixing materials thereof (e.g., solid electrolyte, binder solution, and solvent) using the method 100 of FIG. 1. The smooth slurry may have a desired viscosity suitable for coating due to the mixing method. Further, the smooth slurry may have a maximum particle size below the threshold particle size in order to increase quality of the coating. Increased quality of the coating may be characterized by having more uniform dispersion of solid electrolyte. As one example, the substrate may be a flat metal sheet such as a foil comprising pure aluminum or an aluminum alloy in a planar shape. For example, the substrate may be 15 μm thick and 80 mm wide. However, dimensions of the substrate may vary. In other examples, the slurry may be coated directly onto a surface of an anode or a cathode of a battery. The coating may cover at least a portion of the surface area of the substrate. Coating may include slot-die coating, curtain coating, slide coating, knife over roll coating, comma coating, tape casting, or the like. A rotor-stator pump may pump the smooth slurry into the coating device with a pre-determined flow rate according to the coating speed, foil size, and desired coating thickness.

The method 200 proceeds to 206, wherein the coated substrate is dried. In some examples, the coated substrate may be heated, such as through ovens at 50-150 ° C. In other examples, the coated substrate may be otherwise dried. Drying conditions may change adhesion and cohesion of the coating.

The method 200 ends after 206. By completing the method 200, the substrate may be coated with the smooth slurry and set by drying. For example, an aluminum foil, an anode, or a cathode may be coated with a sulfide slurry in preparation for incorporation into a solid-state battery with the dried sulfide slurry coating being a separator in the battery.

Turning to FIG. 7, a flowchart of a method 700 is shown for producing a casted separator, for example for use in a solid-state battery. The method 700 may include at least some of the steps of the methods 100 and 200 of FIGS. 1 and 2, respectively, or variations thereof.

At 701, the method 700 includes forming a smooth slurry. For example, the method 100 of FIG. 1 may be implemented to produce the smooth slurry. Step 701 includes 702, wherein solid electrolyte, solvent, and binder solution are mixed to form a slurry. Mixing the solid electrolyte, solvent, and binder solution may include dissolver mixing, planetary mixing, or the like under non-vacuum conditions. The solid electrolyte may be an ionically conductive powder such as sulfide powder (or another ionically conductive solid) and the solvent may be hexyl butyrate (or other non-polar solvent such as toluene). In some examples, the binder solution and a second portion of the solid electrolyte are added at a later time than a first portion of the solid electrolyte and the solvent, as described with regards to FIG. 1. The binder solution may be a solution comprising non-polar solvent and a rubber binder.

Following 702, step 701 further includes 704, wherein the slurry is mixed and milled. Mixing and milling the slurry at 704 may include one or more of mixing under non-vacuum conditions at 705, mixing under vacuum conditions at 707, basket milling under non-vacuum conditions at 709 and basket milling under vacuum conditions at 711. Non-vacuum conditions may include pressure being at ambient pressure. Vacuum conditions may include pressure reduced below ambient pressure. Temperature may remain at ambient temperature during mixing and milling at 704. Each of steps 705, 707, 709, and 711 may be repeated one or more times, if included. Orders of completing 705, 707, 709, and 711 may follow different patterns.

For example, as described with reference to FIG. 1, mixing and milling may include first mixing under non-vacuum conditions, then second mixing under vacuum conditions, followed by basket milling under non-vacuum conditions, and finally third mixing under vacuum conditions. Mixing and milling at 704 may include further repetitions of mixing under vacuum conditions and basket milling under non-vacuum conditions, in at least some examples.

As another example, mixing and milling at 704 may include mixing under vacuum conditions at 707, then basket milling under vacuum conditions at 711, followed by repeating mixing under vacuum conditions at 707. Such an example may not include basket milling under non-vacuum conditions or mixing under non-vacuum conditions at 709 and 705, respectively.

As another example, mixing and milling at 704 may include mixing under non-vacuum conditions at 705, then basket milling under non-vacuum conditions at 709, followed by mixing under vacuum conditions at 707. Such an example may not include basket milling under vacuum conditions at 711.

As another example, mixing and milling at 704 may include mixing under vacuum conditions at 707, basket milling under non-vacuum conditions at 709, mixing under non-vacuum conditions at 705, and basket milling under vacuum conditions at 711, in that order. Such an example may not include mixing under non-vacuum conditions at 705.

At 703, the method 700 includes forming a casted separator from the smooth slurry. For example, the method 200 of FIG. 2 may be implemented to form the casted separator. Step 703 includes 706, wherein the smooth slurry is coated onto a substrate to form a coated substrate. For example, the smooth slurry may be slot-die coated onto an aluminum foil, an anode, or a cathode. The coating may be a thin film of approximately even thickness covering and in face sharing contact with at least a portion of the surface area of the substrate.

At 708, the method 700 includes drying the coated substrate to form a casted separator. For example, the coated substrate may be heated to dry the coating.

By performing the method 700, a casted separator may be produced, where the casted separator may be incorporated into a solid-state battery, in at least some examples. The casted separator may have approximately the same or greater ionic conductivity compared to casted separators produced via other methods.

Turning to FIG. 3, a process 300 is schematically depicted for producing a casted separator. For example, the process 300 may be an embodiment of the method 700.

The process 300 begins at a starting step 302 with first mixing a mixture 304 under non-vacuum conditions. Non-vacuum conditions are indicated by a mixing container 352 positioned in an open chamber 308. The mixing container 352 may be any container configured to hold the materials of the smooth slurry throughout the process of forming the smooth slurry. First mixing may occur via a mixing device 354 configured to mix the mixture 304, such as a dissolver mixer, planetary mixer, or any other equipment able to mix solid and liquid components together. For example, the mixture may comprise solid electrolyte powder, non-polar solvent, and rubber binder. The mixture may be approximately 50-80 wt % solids, in at least some examples. As shown, agglomerates 306 may form in the mixture 304, wherein the agglomerates 306 comprise particles of undispersed solid electrolyte. First mixing may produce a first slurry 312 with air bubbles 310 trapped therein due to mixing. Further, agglomerates over a threshold particle size may impede coating in subsequent steps of the process 300 and first mixing under non-vacuum conditions may not break up enough agglomerates. For example, the threshold particles size may be represented in FIG. 3 by the size of a single circle.

Thus, the process 300 includes second mixing under vacuum conditions. Vacuum conditions are indicated by the mixing container 352 positioned in a closed chamber 314. The closed chamber 314 may be a vacuum chamber configured to reduce the pressure therein to the vacuum pressure. Second mixing of the first slurry 312 may result in a second slurry 318, wherein the second slurry 318 is the first slurry 312 with reduced air bubbles 310. However, some agglomerates may still be greater than the threshold particle size, as indicated in FIG. 3 via two or more circles agglomerated. Thus, milling may be performed via a milling device 316 to further reduce maximum agglomerate size. The milling device 316 may be a basket mill, in one example, configured to carry out basket milling. The milling device 316 may be used in the vacuum chamber 314 for milling under vacuum conditions, or an open environment, such as the open chamber 308 for milling under non-vacuum conditions.

As indicated by the arrow 320, repetition of the second mixing step may occur. Further, second mixing under vacuum conditions and basket milling under non-vacuum conditions may be repeated in an alternating pattern until agglomerates are at or below the threshold particle size. A third slurry 322 results after a final basket milling, wherein the third slurry 322 has reduced maximum agglomerate size compared to the second slurry 318, and air bubbles 310 present due to milling. Thus, third mixing may occur to extract the air bubbles 310, resulting in a fourth slurry 324 with agglomerate size below the threshold particle size, and reduced air bubbles 310 or lack thereof. The fourth slurry 324 may be considered a smooth slurry due to having agglomerates below the threshold particle size.

The fourth slurry 324 may be pumped into a coating device 326 using a pump 330. The coating device 326 may be configured to deposit the fourth slurry 324 onto a substrate 328 as a coating 332. The coating device 326 may be a slot-die, as an example. In other examples, the coating device 326 may be a device configured to coat the slurry 324 via curtain coating, slide coating, knife over roll coating, comma coating, tape casting, or the like. Due to the prior mixing steps of the process 300, the fourth slurry 324 may flow with low enough viscosity through the pump 330 and coating device. Coating the substrate 328 may form a coated substrate 336 which is subsequently dried. For example, the coated substrate 336 may be heated in a heater 334 configured to heat the coated substrate 336 to dry the coating by evaporation.

Drying the coated substrate 336 results in a casted separator 340 which is included along with one or more other components, such as an electrode 338, in a solid-state battery 342, in at least some examples. In examples where the substrate 328 is an aluminum foil, the aluminum foil may be delaminated from the coating 332 prior to incorporation of the coating 332 into a battery.

Turning to FIG. 4, a PSD graph 400 is shown. The PSD graph 400 includes a horizontal axis 402 where particle size increases logarithmically in the direction indicated by the arrow thereof, and a vertical axis 404 where volume density percentage increases in the direction indicated by the arrow thereof. The PSD graph 400 shows PSD data for a slurry at different steps of a mixing method according to one or more embodiments of the present disclosure (e.g., the method 100 of FIG. 1).

In the PSD graph 400, a trace 406 (with squares) shows data of the slurry after a first step of the mixing process (e.g., first basket milling). A trace 408 (with diamonds) shows data of the slurry after a second step of the mixing process (e.g., exposure to vacuum while mixing) wherein the second step occurs after the first step. A trace 410 (with triangles) shows data of the slurry after a third step of the mixing process (e.g., second basket milling) wherein the third step occurs after the second step. The first step, the second step, and the third step may be some of the steps of the method, but may not include all steps of the mixing method of the present disclosure. Further, the first step, the second step, the third step (and additional or alternative steps) may not be spread over equal intervals therebetween. A trace 412 (with stars) shows data of a baseline slurry. The baseline slurry may have the same composition but smaller volume, compared to the slurry shown in traces 406, 408, and 410.

The trace 406 may correspond to the trace 506 of FIG. 5. In other words, the first step may be the basket milling for the first duration discussed with reference to FIG. 5, after which data was collected and displayed in the trace 406 and the trace 506. The trace 408 may correspond to the trace 508 of FIG. 5. In other words, the second step may be the mixing under vacuum conditions discussed with reference to FIG. 5, data collected after which shown in the trace 408 and the trace 508. The trace 410 may correspond to the trace 510 of FIG. 5. In other words, the third step may be the basket milling for the second duration discussed with reference to FIG. 5, data collected after which is shown in the trace 410 and the trace 510.

Following the second step wherein the slurry is mixed under vacuum conditions, the trace 408 shows an increase in a number of larger particles compared to following the first step wherein the slurry is basket milled. Further, the D100 of the slurry is greater following the second step than between the second step and the first step. Thus, although mixing under vacuum conditions may decrease viscosity as described above with reference to FIG. 5, mixing under vacuum conditions may also increase a number and size of agglomerates. Following the third step wherein the slurry is basket milled again, the trace 410 shows decreased numbers of larger particle sizes above a threshold particle size 414, compared to traces 406, 408, 410, and 412. Further, the PSD graph 400 does not have a shoulder such as shoulder 804 of FIG. 8 described below. Instead, there is a sharp decline in the trace 410 indicating there are fewer larger particles after the third step. Further, the maximum particle size (e.g., largest particle size with non-zero volume density) is reduced in trace 410 compared to traces 406, 408, and 412. Therefore, a combination of basket milling under non-vacuum conditions and mixing under vacuum conditions may produce a slurry having fewer agglomerates and lower maximum particle size compared to basket milling alone under non-vacuum conditions alone. The slurry produced by completing the first, second, and third steps may be a smooth slurry with a reduced maximum particle size above the threshold particle size 414 and lower numbers of relatively large particle sizes.

Thus, the mixing methods disclosed herein may produce lower particle size, and fewer agglomerates than other methods, thereby increasing coating quality when applied to a substrate as described above. Further, reducing viscosity by including mixing under vacuum conditions may allow for adequate flow of the slurry into a slot-die.

In contrast, slurries prepared by conventional means, such as mixing with a dissolver, planetary mixing system, and/or the like under non-vacuum conditions alone, show remaining agglomerates. Turning to FIG. 8, a PSD graph 800 shows PSD data for a slurry produced by dissolver mixing alone. For example, materials of an electrolyte slurry, such as solid electrolyte and solvent, may be mixed with a dissolver blade rotating at a speed. Dissolver mixing may occur over several intervals of time within the duration, with a range of conditions (e.g., blade rotational speed, blade size, time, etc.) at each interval, in some examples. A benchtop scale may produce 12 mL of slurry comprising 35-50 wt % solids using a 20 mm dissolver disk. Scaling to produce a larger amount of slurry may be achieved by increasing volume of the mixing container, volume of the materials, and a blade diameter. For example, 60 mL of slurry comprising approximately 60 wt % solids may be produced by dissolver mixing as described in the example provided above with 25 mm dissolver disk. Introducing planetary mixing alongside disperser mixing and basket milling may further increase scale.

In the PSD graph 800, a trace 808 (with diamonds) shows data of a mixture not yet mixed by dissolver mixing (e.g., after 0 hours of dissolver mixing). A trace 810 (with squares) shows data of a first slurry produced by dissolver mixing the mixture for a first duration (e.g., after 1 hour of mixing). For example, the first slurry may be approximately 60 wt % solids and dissolver mixing may occur with a 25 mm dissolver blade rotating at 1300 rpm. A trace 812 (with triangles) shows data of the first slurry after dissolver mixing for a second duration longer than the first duration (e.g., after 2 hours of mixing). A trace 814 (with Xs) shows data of the first slurry after dissolver mixing for a third duration longer than the second duration (e.g., after 3 hours of mixing).

An arrow 802 shows a direction of generally shifting towards higher particle size over increased time of mixing (e.g., after longer durations). Further, a shoulder 804 indicates agglomeration of solids in the slurry. As described above, agglomerates in a slurry may impede a coating process and decrease a quality of a coating comprising the slurry. For example, as shown in FIG. 9, a casted separator 900 comprising a coating 902 of a slurry resulting from dissolver mixing alone on a substrate 904 may have undesirable texture due to agglomerates in the slurry. Undesirable texture may include streaks, bumps, other non-uniformities, or a combination thereof. Thus, a solid-state battery comprising the casted separator 900 may experience increased dendrite formation, thereby decreasing effectiveness of the battery.

A second example prior art method may comprise milling with a roller mill following dissolver mixing. For example, a PSD graph 1000 in FIG. 10 shows PSD data for slurries mixed by dissolver mixing and subsequently roller milling with varying roller mill media sizes. A trace 1002 (with diamonds) shows data for a first slurry produced by roller milling for 24 hours with 5 mm media, a trace 1004 (with squares) shows data for a slurry second produced by roller milling for 24 hours with 2 mm media, and a trace 1006 (with triangles) shows data for a slurry third produced by roller milling for 24 hours with a mix of 2 mm and 5 mm media. During milling each of the first slurry, the second slurry, and the third slurry, rotation may occur at approximately 50% of the roller mill critical speed (N_{c}).

Images of casted separators with coatings comprising the slurries with PSD data represented in the PSD graph 1000 are shown in FIGS. 11A-11C. A first image 1102 in FIG. 11A shows a casted separator comprising the substrate 904 and a first coating 1108 comprising a slurry corresponding to the trace 1002 in the PSD graph 1000 of FIG. 10. A second image 1104 in FIG. 11B shows a casted separator comprising the substrate 904 and a second coating 1110 comprising a slurry corresponding to the trace 1004 in the PSD graph 1000 of FIG. 10. A third image 1106 in FIG. 11C shows a casted separator comprising the substrate 904 and a third coating 1112 comprising a slurry corresponding to the trace 1006 of the PSD graph 1000 of FIG. 10. As shown in the first image 1102, the second image 1104, and the third image 1106, textures of the coatings vary depending on corresponding PSDs of the slurries shown in FIG. 10. Compared with the coating 902 of FIG. 9, the first coating 1108, the second coating 1110, and the third coating 1112 have smoother texture due to reduced agglomerate size after roller milling. Thus, the casted separators including coatings which have been roller milled may reduce dendrite formation.

Further, as shown in the PSD graph 1000 of FIG. 10, milling with the roller mill after dissolver mixing may reduce the maximum agglomerate size in the slurry. Thus, agglomerates may be physically broken up and suspended in the slurry following formation during mixing using methods based on a mechanical process such as roller milling or other type of milling. However, as described above, roller milling produces lower yield, thereby increasing resource demand to produce a similar volume of slurry.

Images of example casted separators produced by a method of the present disclosure are shown in FIGS. 6A, 6B, and 6C. A first separator 600 shown in FIG. 6A comprises a first coating 602 on the substrate 904. A second separator 608 shown in FIG. 6B comprises a second coating 604 on the substrate 904. A third separator 610 shown in FIG. 6C comprises a third coating 606 on the substrate 904. The first coating 602, the second coating 604, and the third coating 606 may comprise a slurry at different steps of the mixing method of the present disclosure, such as the method 100 of FIG. 1. The first coating 602 may comprise the slurry with PSD according to the trace 406 of FIG. 4 and viscosity according to the trace 506 of FIG. 5. The second coating 604 may comprise a slurry with PSD according to the trace 408 of FIG. 4 and viscosity according to the trace 508 of FIG. 5. The third coating may comprise a slurry with PSD according to the trace 410 of FIG. 4 and viscosity according to the trace 510 of FIG. 5.

A surface texture of the second coating 604 is less smooth than the first coating 602, indicating a presence of greater number and/or size of agglomerates following dissolver mixing under vacuum conditions. However, the texture of the third coating 606 is more smooth than the second coating 604, the first coating 602, and the coating 902 of FIG. 9 due to reduced agglomerates as shown in comparing respective PSDs. For example, fewer streaks, bumps, and other undesired uneven surface textures are visibly evident due to basket milling reducing agglomerate size. Thus, a slurry produced by the methods disclosed herein, including repeatedly basket milling and mixing under vacuum conditions, may be more smooth compared to slurries produced by other methods, such as the prior art methods described in regards to FIGS. 8-11. The smooth slurry may include fewer agglomerates, and a maximum particle size below the threshold particle size, thereby decreasing surface texture of a coating resulting from applying the smooth slurry to a substrate, such as by the method 200 of FIG. 2. The decreased surface texture may indicate materials of the smooth slurry are more thoroughly mixed together, including a more even distribution of solid electrolyte. Thus, a likelihood of dendrite formation in the coating may be reduced when used as a separator in a solid-state battery.

The technical effect of the mixing and coating methods disclosed herein is to produce a slurry with reduced agglomerate number and particle size. For example, the slurry may be a sulfide solid electrolyte slurry and may be coated onto an aluminum foil, an anode, a cathode, or other substrate. The coating comprising the slurry may be dried and used as a separator in a solid-state battery. By reducing the viscosity of the slurry with mixing under vacuum conditions, the slurry may flow more smoothly into a coating device for more effective coating. Further, by reducing the agglomerate number and size, solid electrolyte, such as sulfide, may be evenly distributed within the separator and formation of dendrites may be prevented, thereby increasing effectiveness and lengthening a lifespan of the battery.

As used herein, the term “approximately” is construed to mean plus or minus five percent of the range unless otherwise specified. FIGS. 3, 6A-6C, 9, and 11A-11C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of preparing a solid state battery separator, comprising:
pre-mixing a first portion of a solid electrolyte and a solvent to form a mixture;
first mixing a binder solution, a second portion of the solid electrolyte, and the mixture under non-vacuum conditions to form a slurry;
second mixing the slurry under vacuum conditions to form a mixed slurry;
alternating milling and second mixing the mixed slurry to form a smooth slurry with particles smaller than a threshold particle size;
coating a substrate with the smooth slurry to produce a coated substrate; and
drying the coated substrate.

2. The method of claim 1, wherein milling occurs under vacuum conditions.

3. The method of claim 1, wherein milling occurs under non-vacuum conditions.

4. The method of claim 1, wherein the threshold particle size is within a range of 1-50 μm.

5. The method of claim 1, wherein the smooth slurry is approximately 50-80 wt % solids.

6. The method of claim 1, wherein the solid electrolyte is an ionically conductive powder, the solvent is a non-polar solvent, and the binder solution comprises a dilution solvent and a rubber binder.

7. The method of claim 6, wherein the rubber binder is nitrile butadiene rubber, hydrogenated nitrile butadiene rubber, styrene-butadiene copolymer, styrene-butadiene-styrene, polyvinylidene fluoride, and/or hexafluoroporpylene.

8. The method of claim 1, wherein the threshold particle size is one third or less of a coating thickness of the smooth slurry on the substrate.

9. A method of preparing a casted separator, comprising:
combining a solid electrolyte, a solvent, and a binder solution to form a slurry;
mixing the slurry to form a smooth slurry, wherein mixing the slurry includes second mixing under vacuum conditions, followed by basket milling under vacuum and/or non-vacuum conditions;
coating the smooth slurry onto a substrate to form a coated substrate; and
drying the coated substrate to form the casted separator.

10. The method of claim 9, wherein mixing further includes third mixing under vacuum conditions after basket milling under vacuum and/or non-vacuum conditions and before coating.

11. The method of claim 9, wherein coating includes slot-die coating, curtain coating, slide coating, knife over roll coating, tape casting, or comma coating.

12. The method of claim 9, wherein the solid electrolyte is sulfide powder, the solvent comprises hexyl butyrate, toluene, xylene, anisole, heptane, or butyl butyrate, the binder solution comprises a non-polar solvent and a rubber binder, and the substrate is an aluminum foil, an anode, or a cathode.

13. The method of claim 9, wherein the casted separator is incorporated in a solid-state battery.

14. The method of claim 9, wherein second mixing under vacuum conditions and basket milling under non-vacuum conditions are repeated in an alternating pattern until a maximum particle size of the smooth slurry is less than a threshold particle size and a viscosity of the smooth slurry is less than a threshold viscosity.

15. The method of claim 14, wherein the threshold viscosity is within a range of 1-50 μm.

16. The method of claim 14, wherein the threshold particle size is approximately one third or less of a thickness of the casted separator.

17. A method of mixing a slurry for a solid state battery separator, comprising:
first mixing a solvent, a solid electrolyte, and a binder solution under non-vacuum conditions to form a slurry;
second mixing the slurry under vacuum conditions to form a mixed slurry;
basket milling the mixed slurry under non-vacuum conditions to form a milled slurry;
if the largest particle size of the milled slurry is not less than a threshold particle size, repeatedly second mixing the milled slurry under vacuum conditions followed by basket milling the milled slurry under non-vacuum conditions until the largest particle size of the milled slurry is less than the threshold particle size; and
third mixing the milled slurry under vacuum conditions to form a smooth slurry with a viscosity below a threshold viscosity.

18. The method of claim 17, wherein the method further comprises coating an aluminum foil, an anode, or a cathode with the smooth slurry to form a coated substrate and drying the coated substrate to form a casted separator.

19. The method of claim 18, wherein the threshold particle size is approximately one third or less of a thickness of the casted separator.

20. The method of claim 17, wherein the threshold particle size is within a range of 1-50 μm.
